(19) United States
(12) Patent Application Publication
(10) Pub. No.: US 2025/0366574 A1
(43) Pub. Date: Dec. 4, 2025

(54) ONE PIECE, MULTIPLE LAYER WATCH BAND

(71) Applicant: MH BERTUCCI, INC., Gurnee, IL (US)

(72) Inventor: Michael H. Bertucci, Gurnee, IL (US)

(21) Appl. No.: 19/222,622

(22) Filed: May 29, 2025

Related U.S. Application Data
(60) Provisional application No. 63/653,627, filed on May 30, 2024.

(51) Int. Cl. A44C 5/00; B32B 3/26; B32B 5/02; B32B 7/09; B32B 25/10

(52) U.S. Cl. CPC A44C 5/0053; B32B 3/266; B32B 5/024; B32B 7/09; B32B 25/10; B32B 2262/0261

(57) ABSTRACT

A watch band that comprises an elastomer body and a nylon member. The elastomer body has a tip at one end and a buckle at the other. The elastomer body comprises adjustment holes. The buckle comprises a buckle tongue which is configured to insert into the adjustment holes. The elastomer body comprises an outside surface and an inside surface, wherein the inside surface is meant to contact the wrist of a user when the user wears the watch band. The nylon member is attached to the elastomer body such that the adjustment holes in the elastomer body are free of nylon. Specifically, the nylon member comprises a nylon webbing inlay that is preferably stitched to the elastomer body. The nylon member works to bestow the elastomer body with high tensile, tear and cracking resistance.

The present application claims the benefit of U.S. Provisional Application Ser. No. 63/653,627, filed May 30, 2024, which is hereby incorporated by reference in its entirety.

### BACKGROUND

The present invention generally relates to watch bands, and more specifically relates to a watch band that comprises an elastomer band comprising a nylon inlay.

Watch bands are typically made of metal, leather, fabric, an elastomer, or nylon. In the watch industry, all these materials are common to use for the band. Regardless of the material, watch bands are typically formed of a single layer.

Regarding metal or leather bands, there simply is no need to provide multiple layers because the band is sufficiently sturdy, etc. without having to provide more than one layer.

Fabric watch bands tend to be provided as being a single layer to avoid having seams on the inside surface of the watch band (i.e., against the wrist) because seams on the inside of the watch band tend to result in discomfort.

Single piece elastomer only bands, such those made of silicon, FKM (Fluoroelastomer), PVC (Polyvinyl Chloride), PU (Polyurethane), etc., tend to split or crack relatively easily from wear and tear. A solution is needed to make elastomer bands more durable.

Single piece nylon only bands tend to fray at certain points, specifically at the tip and around the buckle holes. A solution is needed to make nylon bands less susceptible to fraying, especially in those areas.

### SUMMARY

One object of an embodiment of the present invention is to provide a durable watch band which comprises an elastomer.

Another object of an embodiment of the present invention is to provide a watch band which resists fraying in key areas despite the watch band comprising nylon.

Briefly, an embodiment of the present invention provides a watch band that comprises an elastomer body and a nylon member. Specifically, the elastomer body comprises a first end and a second end. The first end of the elastomer body comprises a tip. The second end of the elastomer body attaches to a buckle. The elastomer body comprises adjustment holes. The buckle comprises a buckle tongue which is configured to insert into the adjustment holes in the elastomer body. The elastomer body comprises an outside surface and an inside surface, wherein the inside surface is meant to contact the wrist of a user when the user wears the watch band. The nylon member is attached to the elastomer body such that the adjustment holes in the elastomer body are free of nylon. Specifically, the nylon member comprises a nylon webbing inlay that is preferably stitched to the elastomer body. The nylon member works to bestow the elastomer body with high tensile, tear and cracking resistance. In effect, the nylon-a very rugged material-reinforces the relatively weaker elastomer.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a front view of a watch band (i.e., showing the outside surface of the watch band) which is in accordance with an embodiment of the present invention; and

FIG. 2 is a back view of the watch band shown in FIG. 1 (i.e., showing the inside surface of the watch band, wherein the inside surface is meant to contact the wrist of a user when the user wears the watch band).

### DESCRIPTION

While this invention may be susceptible to embodiment in different forms, there is shown in the drawings and will be described herein in detail, a specific embodiment with the understanding that the present disclosure is to be considered an exemplification of the principles of the invention and is not intended to limit the invention to that as illustrated.

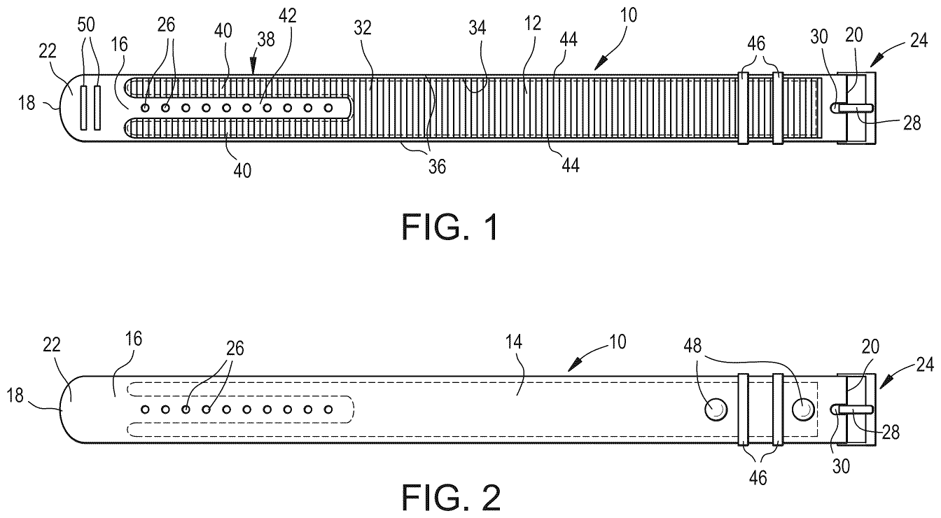

FIG. 1 is a front view of a watch band which is in accordance with an embodiment of the present invention (i.e., showing the outside surface of the watch band). FIG. 2 is a back view of the watch band shown in FIG. 1 (i.e., showing the inside surface of the watch band, wherein the inside surface is meant to contact the wrist of a user when the user wears the watch band).

As shown, the watch band comprises an elastomer body. The elastomer body comprises a first end and a second end. The first end of the elastomer body comprises a tip while the second end of the elastomer body attaches to a buckle. The elastomer body comprises adjustment holes, and the buckle comprises a buckle tongue which extends from an opening in the elastomer body and is configured to insert into the adjustment holes in the elastomer body.

As shown in FIG. 1, the watch band also comprises a nylon member. The nylon member is attached to the elastomer body. Preferably, the nylon member is attached to the elastomer body at a location such that the adjustment holes in the elastomer body are free of nylon. This is beneficial because the elastomer has inherent advantages over the nylon relative to the tendency to fray. This is especially helpful at common points of fraying, said points being the tip and adjustment hole areas. These fraying points are effectively eliminated by means of the elastomer. The elastomer body comprises a recess area or “inlay” area and it is in this recess area that the nylon member is disposed, edge stitched to the elastomer to secure the two materials together, effectively forming a stronger band. The reinforcement nylon improves tensile strength and reduces tearing (common issues with elastomer only bands). The elastomer recess side walls protect the nylon from fraying and provide a strong area for the buckle to be secured (common issues with nylon only bands). The union of the two materials improves the inherent issue with single only materials, i.e., together both single materials are made more durable.

Specifically, the nylon member preferably comprises a nylon webbing inlay that is preferably stitched to the elastomer body. The nylon member works to bestow the elastomer body with high tensile, tear and cracking resistance. In effect, the nylon member, formed of a very rugged material, reinforces the relatively weaker elastomer body. As such, the watch band, despite comprising an elastomer, does not tend to split or crack relatively easily from wear and tear. Furthermore, the watch band, despite comprising nylon, does not tend to fray at certain points, specifically at the tip and around the adjustment holes.

As shown in FIG. 1, preferably the nylon member comprises a forked portion comprising two fingers with a space between the two fingers. The adjustment holes in the elastomer band are preferably located in the space between the two fingers of the nylon member. This provides that the adjustment holes are formed of elastomer and are free of nylon, making them resistant to fraying.

As shown in FIGS. 1 and 2, preferably the nylon member is stitched to the elastomer body all the way generally along the outer perimeter of the nylon member. This provides a secure attachment between the nylon member and the elastomer body and eliminates the possibility of the nylon member separating from the elastomer body at any point along the outer perimeter of the nylon member.

In addition to the buckle, the watch band also comprises at least one keeper loop (preferably two, as shown in FIGS. 1 and 2) for receiving the tip of the elastomer body when the watch band is worn by a user. Preferably, the keeper loops, the buckle and the buckle tongue are all formed of metal, such as a matte stainless steel. Although not shown, preferably a pin extends through the elastomer body proximate the second end, is connected to the buckle, and holds the buckle tongue. As shown in FIG. 2, retention bumps may be provided on the inside surface of the watch band for retaining the keeper loops between the retention bumps.

Regarding choice of materials, the elastomer body is preferably formed of FKM (Fluoroelastomer) or some other type of suitable elastomer. The nylon member is preferably formed of a nylon material that is webbed (i.e., has ridges, as shown in FIG. 1) to give the nylon member some texture. In contrast, the elastomer body is preferably generally smooth although the elastomer body could be provided with, for example, raised embosses generally proximate the tip.

Although by no means required by the present invention, the elastomer body could be 2. 7 cm in length and about 22 mm in width. The adjustment hole that is closest to the tip could be 28 mm from the tip. The adjustment holes could extend across a 65 mm line from end to end. Each of the retention bumps could be 4 mm high and 7 mm wide. The retention bumps could be 45 mm apart, and the retention bump that is closest to the buckle could be 15 mm from the second end of the elastomer body. Each of the keeper loops could be 6.5 mm high measuring from the inside surface of opening provided by the keeper loop. The watch band could have a 2.75 mm overall thickness. Of course, all of these dimensions could be different without straying from the spirit and scope of the present invention.

Regardless, an embodiment of the present invention comprises a durable watch band which comprises an elastomer. The watch band which resists fraying in key areas despite the watch band comprising nylon. A nylon member works to bestow an elastomer body with high tensile, tear and cracking resistance. In effect, the nylon-a very rugged material-reinforces the relatively weaker elastomer. The nylon member makes the elastomer stronger while the elastomer protecting edges by the nylon and eliminates fray. The nylon is contained in the form of an inlay with the elastomer (which covers the entire length of the band), completely surrounded by the elastomer.

The inside surface of the watch band provides an elastomer surface making the watch band comfortable for the user. The outside surface includes nylon, but that nylon is by elastomer edges to prevent fraying and add tensile strength.

What is claimed is:

1. A watch band comprising: an elastomer body; and a nylon member attached to the elastomer body.

2. The watch band as recited in claim 1, wherein the elastomer body comprises a first end and a second end.

3. The watch band as recited in claim 1, wherein the elastomer body comprises a first end and a second end, wherein the first end of the elastomer body comprises a tip, and wherein the second end of the elastomer body attaches to a buckle.

4. The watch band as recited in claim 1, wherein the elastomer body comprises adjustment holes.

5. The watch band as recited in claim 1, wherein the elastomer body comprises a first end and a second end, wherein the first end of the elastomer body comprises a tip, wherein the second end of the elastomer body attaches to a buckle, wherein the elastomer body comprises adjustment holes, and wherein the buckle comprises a buckle tongue which is configured to insert into the adjustment holes in the elastomer body.

6. The watch band as recited in claim 1, wherein the elastomer body comprises an outside surface and an inside surface, wherein the inside surface is meant to contact the wrist of a user when the user wears the watch band.

7. The watch band as recited in claim 1, wherein the elastomer body comprises a first end and a second end, wherein the first end of the elastomer body comprises a tip, wherein the second end of the elastomer body attaches to a buckle, wherein the elastomer body comprises adjustment holes, wherein the nylon member is attached to the elastomer body such that the adjustment holes in the elastomer body are free of nylon.

8. The watch band as recited in claim 1, wherein the nylon member comprises a nylon webbing inlay that is stitched to the elastomer body.

9. The watch band as recited in claim 1, wherein, wherein the elastomer body comprises a first end and a second end, wherein the second end of the elastomer body attaches to a buckle, wherein the elastomer body comprises adjustment holes, wherein the buckle comprises a buckle tongue which is configured to insert into the adjustment holes in the elastomer body, wherein the elastomer body comprises an outside surface and an inside surface, wherein the inside surface is meant to contact the wrist of a user when the user wears the watch band, and wherein the nylon member is attached to the elastomer body such that the adjustment holes in the elastomer body are free of nylon.

10. The watch band as recited in claim 1, wherein, wherein the elastomer body comprises a first end and a second end, wherein the second end of the elastomer body attaches to a buckle, wherein the elastomer body comprises adjustment holes, wherein the buckle comprises a buckle tongue which is configured to insert into the adjustment holes in the elastomer body, wherein the elastomer body comprises an outside surface and an inside surface, wherein the inside surface is meant to contact the wrist of a user when the user wears the watch band, and wherein the nylon member is attached to the elastomer body such that the adjustment holes in the elastomer body are free of nylon, wherein the nylon member comprises a nylon webbing inlay that is stitched to the elastomer body.

11. The watch band as recited in claim 1, wherein the nylon member is configured to bestow the elastomer body with high tensile, tear and cracking resistance, wherein the nylon member reinforces the elastomer body.

12. The watch band as recited in claim 1, wherein the elastomer body comprises adjustment holes, wherein the nylon member comprises a forked portion comprising two fingers with a space between the two fingers, wherein the adjustment holes in the elastomer band are located in the space between the two fingers of the nylon member.

13. The watch band as recited in claim 1, wherein the nylon member is stitched to the elastomer body all the way along an outer perimeter of the nylon member.

14. The watch band as recited in claim 1, wherein the elastomer body comprises a first end and a second end, wherein the first end of the elastomer body comprises a tip, wherein the second end of the elastomer body attaches to a buckle, wherein the elastomer body comprises adjustment holes, and wherein the buckle comprises a buckle tongue which is configured to insert into the adjustment holes in the elastomer body, wherein the watch band also comprises at least one keeper loop for receiving the tip of the elastomer body when the watch band is worn by a user, wherein the at least one keeper loop, the buckle and the buckle tongue are all formed of metal, and retention bumps are provided on an inside surface of the watch band for retaining the keeper loops between the retention bumps.

15. The watch band as recited in claim 1, wherein the elastomer body is formed of FKM (Fluoroelastomer) and the nylon member is formed of a nylon material that is webbed
